(19) United States
(12) Patent Application Publication
(10) Pub. No.: US 2005/0249604 A1
(43) Pub. Date: Nov. 10, 2005

(54) Fan

(75) Inventors: Hsiu-Wei Wu, Taoyuan Hsien (TW); Yi-Ling Chen, Taoyuan Hsien (TW); Kuo-Chen Huang, Taoyuan Hsien (TW); Shang-Yen Tsai, Taoyuan Hsien (TW); Chieh-Lung Ho, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/123,118

(22) Filed: May 6, 2005

(30) Foreign Application Priority Data
May 7, 2004 (TW) 93112882

(51) Int. Cl. F03B 1/02

(52) U.S. Cl. 416/244 R

(57) ABSTRACT

Fans. A fan comprises a hub, a ring and a plurality of flat blades. The ring surrounds the hub without substantial contact therewith and is connected to the hub by at least one connecting arm. The flat blades are disposed on the ring and comprise active surface which extending lines of the active surfaces are tangent to a circle.

### BACKGROUND

The present invention relates to a fan, and particularly to fans capable of reducing windage and noise.

FIG. 1 shows a conventional fan 100. The fan 100 comprises a hub 102 and a plurality of fan blades 104 directly connected to the hub 102. The frontal surfaces 106 of the fan blades 104 are tangent to the edge of the hub. When the number of fan blades 104 is increased, space between the fan blades 104 is limited, increasing windage and noise of the fan 100. Conversely, when the number of fan blades 104 is reduced, the total active area of the fan blades 104 is reduced accordingly, thus reducing the airflow efficiency of the fan 100.

Typically, a conventional fan 100 with 13 fan blades 104 is employed to balance adequate airflow efficiency without significantly increasing the windage and noise thereof. In a compact electrical device, however, heat dissipation efficiency is enormously required due to the compacted volume thereof, which exceeds the adequate airflow efficiency of the conventional fan 100. As a result, a fan with enhanced heat dissipation efficiency and reducing windage and noise thereof is required.

### SUMMARY

In view of the problem, an object of the present invention is to provide a fan to enhance heat dissipation and reduce the windage and noise.

In an exemplary embodiment of the present invention, a fan comprises a hub, a ring and a plurality of flat blades. The ring surrounds the hub without substantial contact therewith and is connected to the hub by at least one connecting arm. The flat blades are disposed on the ring and each comprises an extending line tangent to a specific imaginary circle.

In some embodiments, the active surfaces have shapes of rectangles, ladder-sided polygons, tapered polygons, or polygons with taper-and-ladder sides.

In some embodiments, the ring has a rectangular cross-section, an outward tapered shape, an inward tapered shape, or a two-sided tapered shape.

In some embodiments, the connection arm has a rectangular cross-section, a teardrop shape, a polygon, or a rounded polygon.

In some embodiments, the fan can be an axial-flow fan or a side-blown fan, and the flat blades do not substantially contact the hub.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1 is a schematic view of a conventional fan;

FIG. 2 is a schematic view of an embodiment of a fan:

FIG. 3 is a schematic view of some embodiments of cross-sections of the ring of the fan;

FIG. 4 is a schematic view of some embodiments of cross-sections of the connection arm of the fan; and

FIG. 5 is a schematic view of some embodiments of cross-sections of the active surfaces of the flat blades of the fan.

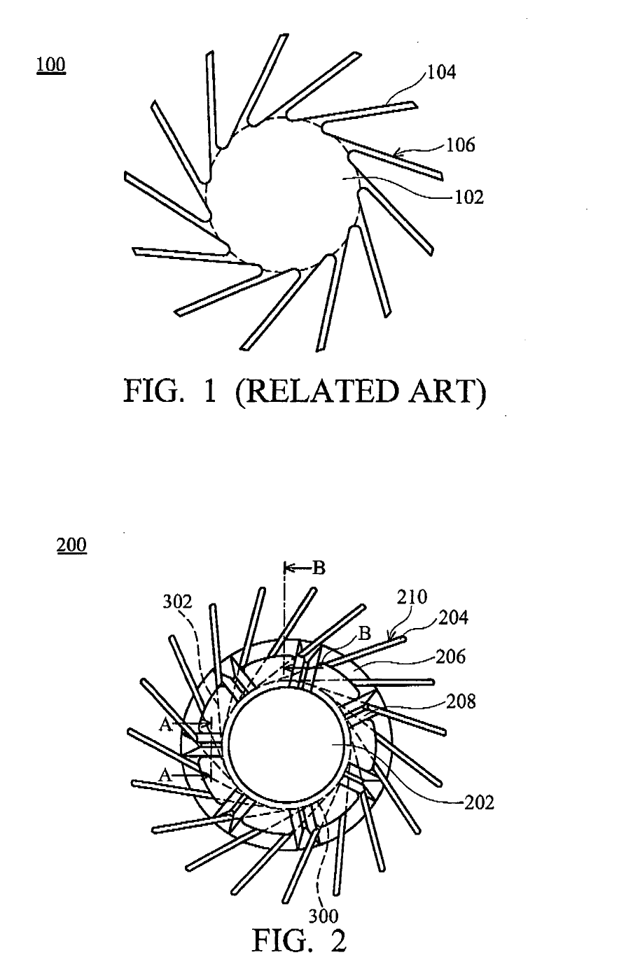

### DETAILED DESCRIPTION

FIG. 2 shows an embodiment of a fan 200. The fan 200 comprises a hub 202, a ring 206, connection arms 208, and a plurality of flat blades 204. The fan 200 can be an axial-flow fan or a side-blown fan.

In some embodiments, the hub 202 is a hat-shaped structure with a stator disposed therein. The hub 202 can be metal or plastic.

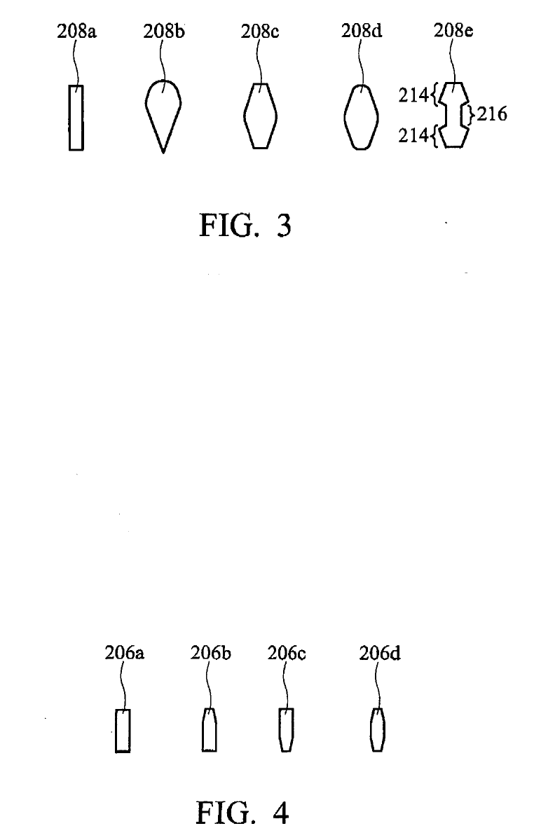

The ring 206 is disposed surrounding the hub 202 without substantial contact therewith, and is connected to the hub 202 by the connecting arms 208. In some embodiments, the cross-section of the ring 206 can be a rectangle 206a, an outward tapered shape 206b, an inward tapered shape 206c, or a two-sided tapered shape 206d, respectively shown in FIG. 3. When the thickness of the cross-section of the ring 206 varies, the thick portion in the cross-section enhances the structure of the ring 206 for stress and reinforces axial connection between the ring 206 and the flat blades 204. Further, the thin portion in the cross-section increases the total active area of the flat blades 204 and reinforces radial connection between the ring 206 and the flat blades 204. The ring 202 can be made of metal or plastic.

The connection arms 208 connect the hub 202 and the ring 206. The number and size of the connection arms 208 are not limited. In some embodiments, the cross-sections of the connection arms 208 can be a rectangle 208a, a teardrop shape 208b, a polygon 208c, a round-cornered polygon 208d, or a bone shape 208e with both side portions 214 thereof thicker than a middle portion 216 thereof, respectively shown in FIG. 4. The side portions 214 of the bone shape 208e can be tapered. When at least one side portion of the connection arm 208 is tapered, the connection arm 208 enhances the airflow efficiency and reduces windage of the fan 200. Further, when the side portions of the connection arm 208 are thicker than the middle portion thereof, the windage can be further reduced. The connection arms 208 can be metal or plastic.

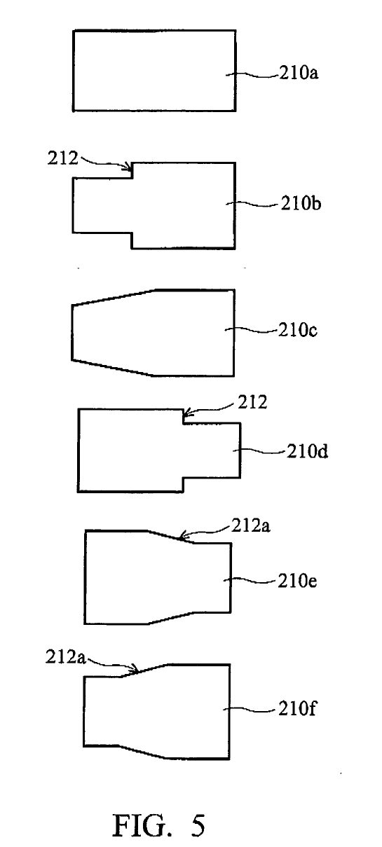

The flat blades 204 are disposed on the ring 206 around the hub 202, and each comprises an extending line 302 of active surface 210 of the blade 204 tangent to a specific imaginary circle 300. One end of the blades 204 contact with the ring 206, and other end of the blades 204 don't contact with the ring 206. Thus, windage of the flat blades 204 is minimized, and the airflow efficiency of the fan 200 is enhanced. The active surfaces 210 can be flat to maximize the total active area of the flat blades 204. In some embodiments, the active surfaces 210 have rectangular shapes 210a, ladder-sided polygons 210b and 210d with ladder sides 212, tapered polygons 210c, and polygons 210e and 210f with taper-and-ladder sides 212a, respectively shown in FIG. 5.

In some embodiments, the flat blades 204 are disposed on the ring 206 without substantial contact to the hub 202, and the extending lines of the active surfaces 210 of the flat blades 204 are tangent to a specific imaginary circle. Thus, when extending lines of flat blades 204 crisscross with other, space between the flat blades 204 is maintained with desired windage. As a result, the number of the flat blades 204 can potentially be increased to more than 13 to enhance airflow efficiency without significantly increasing the windage and noise of the fan 200. In some embodiments, 16 to 20 flat blades 204 can be employed.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A fan, comprising:
a hub;
a ring surrounding the hub without substantial contact therewith and connected to the hub by at least one connection arm; and
a plurality of blades disposed on the ring, each of the blades comprising an active surface, wherein extending lines of the active surfaces are tangent to a specific imaginary circle.

2. The fan as claimed in claim 1, wherein the active surfaces are rectangular, ladder-sided polygons, tapered polygons, or polygons with taper-and-ladder sides.

3. The fan as claimed in claim 1, wherein the ring has a rectangular, an outward tapered, an inward tapered, or a two-sided tapered cross-section.

4. The fan as claimed in claim 1, wherein the connection arm has a rectangular, a teardrop shape, a polygon, a round-cornered polygon, or a bone shape cross-section with both side portions thereof thicker than a middle portion thereof.

5. The fan as claimed in claim 4, wherein the side portions of the bone shape are tapered.

6. The fan as claimed in claim 1, wherein the fan is an axial-flow fan or a side-blown fan.

7. The fan as claimed in claim 1, wherein the blades do not substantially contact the hub.

8. The fan as claimed in claim 1, wherein the blades are flat blades.

9. The fan as claimed in claim 1, wherein One end of the blades contact with the ring, and other end of the blades don't contact with the ring.
